(19) United States
(12) Patent Application Publication
(10) Pub. No.: US 2022/0335212 A1
(43) Pub. Date: Oct. 20, 2022

(54) DATA VISUALIZATION WITH DERIVED DIMENSIONAL HIERARCHY

(71) Applicant: SIGMA COMPUTING, INC., SAN FRANCISCO, CA (US)

(72) Inventors: JASON D. FRANTZ, SAN FRANCISCO, CA (US); ROBERT C. WOOLLEN, SAN RAFAEL, CA (US); KENNETH TRUONG, TEMPLE CITY, CA (US); ALEXIS JOHNSON, SAN FRANCISCO, CA (US); NIPURN DOSHI, REDWOOD CITY, CA (US)

(21) Appl. No.: 17/721,145

(22) Filed: Apr. 14, 2022

Related U.S. Application Data
(60) Provisional application No. 63/175,479, filed on Apr. 15, 2021.

(51) Int. Cl. G06F 40/18; G06F 16/28

(52) U.S. Cl. CPC G06F 40/18; G06F 16/283

(57) ABSTRACT

Data visualization with derived dimensional hierarchy including presenting, by a table manager via a graphical user interface (GUI) on a client computing system, column identifiers from a table retrieved from a cloud-based data warehouse; receiving, by the table manager, an instruction to generate a first visualization, wherein the instruction to generate the first visualization comprises a selection of column identifiers; deriving, by the table manager, a dimensional hierarchy based on the selected column identifiers; and generating, by the table manager based on the derived dimensional hierarchy, the first visualization in the GUI of the client computing system.

### CROSS-REFERENCE TO RELATED APPLICATIONS

This application is a non-provisional application for patent entitled to a filing date and claiming the benefit of earlier-filed U.S. Provisional Patent Application Ser. No. 63/175,479, filed Apr. 15, 2021.

### BACKGROUND

### Field of the Invention

The field of the invention is data processing, or, more specifically, methods, apparatus, and products for data visualization with derived dimensional hierarchy.

### Description of Related Art

Modern businesses may store large amounts of data in remote databases within cloud-based data warehouses. This data may be accessed using database statement languages, such as structured query language (SQL). Manipulating the data stored in the database may require constructing complex queries beyond the abilities of most users. Further, composing and issuing database queries efficiently may also be beyond the abilities of most users.

### SUMMARY

Methods, systems, and apparatus for data visualization with derived dimensional hierarchy including presenting, by a table manager via a graphical user interface (GUI) on a client computing system, column identifiers from a table retrieved from a cloud-based data warehouse; receiving, by the table manager, an instruction to generate a first visualization, wherein the instruction to generate the first visualization comprises a selection of column identifiers; deriving, by the table manager, a dimensional hierarchy based on the selected column identifiers; and generating, by the table manager based on the derived dimensional hierarchy, the first visualization in the GUI of the client computing system.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for data visualization with derived dimensional hierarchy according to embodiments of the present invention.

FIG. 2 sets forth a block diagram of an example system configured for data visualization with derived dimensional hierarchy according to embodiments of the present invention.

FIG. 3 sets forth a block diagram of an example system configured for data visualization with derived dimensional hierarchy according to embodiments of the present invention.

FIG. 4 sets forth a flow chart illustrating an exemplary method for data visualization with derived dimensional hierarchy according to embodiments of the present invention.

FIG. 5 sets forth a flow chart illustrating an exemplary method for data visualization with derived dimensional hierarchy according to embodiments of the present invention.

FIG. 6 sets forth a flow chart illustrating an exemplary method for data visualization with derived dimensional hierarchy according to embodiments of the present invention.

### DETAILED DESCRIPTION

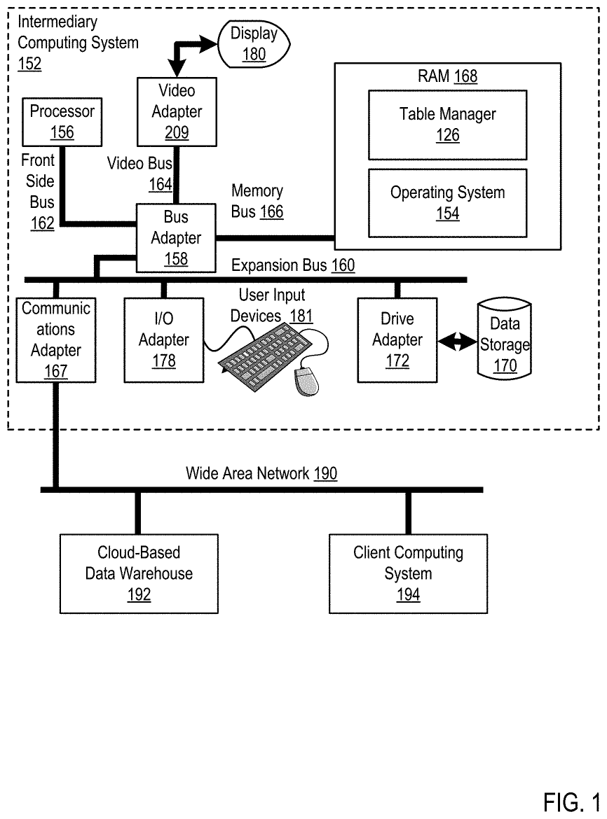

Exemplary methods, apparatus, and products for data visualization with derived dimensional hierarchy in accordance with the present invention are described with reference to the accompanying drawings, beginning with FIG. 1. FIG. 1 sets forth a block diagram of automated computing machinery comprising an exemplary intermediary computing system 152 configured for data visualization with derived dimensional hierarchy according to embodiments of the present invention. The intermediary computing system 152 of FIG. 1 includes at least one computer processor 156 or ‘CPU’ as well as random access memory 168 (‘RAM’) which is connected through a high speed memory bus 166 and bus adapter 158 to processor 156 and to other components of the intermediary computing system 152.

Stored in RAM 168 is an operating system 154. Operating systems useful in computers configured for data visualization with derived dimensional hierarchy according to embodiments of the present invention include UNIX™, Linux™, Microsoft Windows™, AIX™, and others as will occur to those of skill in the art. The operating system 154 in the example of FIG. 1 is shown in RAM 168, but many components of such software typically are stored in non-volatile memory also, such as, for example, on data storage 170, such as a disk drive. Also stored in RAM is the table manager 126, a module for data visualization with derived dimensional hierarchy according to embodiments of the present invention.

The intermediary computing system 152 of FIG. 1 includes disk drive adapter 172 coupled through expansion bus 160 and bus adapter 158 to processor 156 and other components of the intermediary computing system 152. Disk drive adapter 172 connects non-volatile data storage to the intermediary computing system 152 in the form of data storage 170. Disk drive adapters useful in computers configured for data visualization with derived dimensional hierarchy according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example intermediary computing system 152 of FIG. 1 includes one or more input/output (‘I/O’) adapters 178. I/O adapters implement user-oriented input/output through, for example, software drivers and computer hardware for controlling output to display devices such as computer display screens, as well as user input from user input devices 181 such as keyboards and mice. The example intermediary computing system 152 of FIG. 1 includes a video adapter 209, which is an example of an I/O adapter specially designed for graphic output to a display device 180 such as a display screen or computer monitor. Video adapter 209 is connected to processor 156 through a high speed video bus 164, bus adapter 158, and the front side bus 162, which is also a high speed bus.

The exemplary intermediary computing system 152 of FIG. 1 includes a communications adapter 167 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for data visualization with derived dimensional hierarchy according to embodiments of the present invention include modems for wired dial-up communications, Ethernet (IEEE 802.3) adapters for wired data communications, and 802.11 adapters for wireless data communications.

The communications adapter 167 is communicatively coupled to a wide area network 190 that also includes a cloud-based data warehouse 192 and a client computing system 194. The cloud-based data warehouse 192 is a computing system or group of computing systems that hosts a database or databases for access over the wide area network 190. The client computing system 194 is a computing system that accesses the database using the table manager 126.

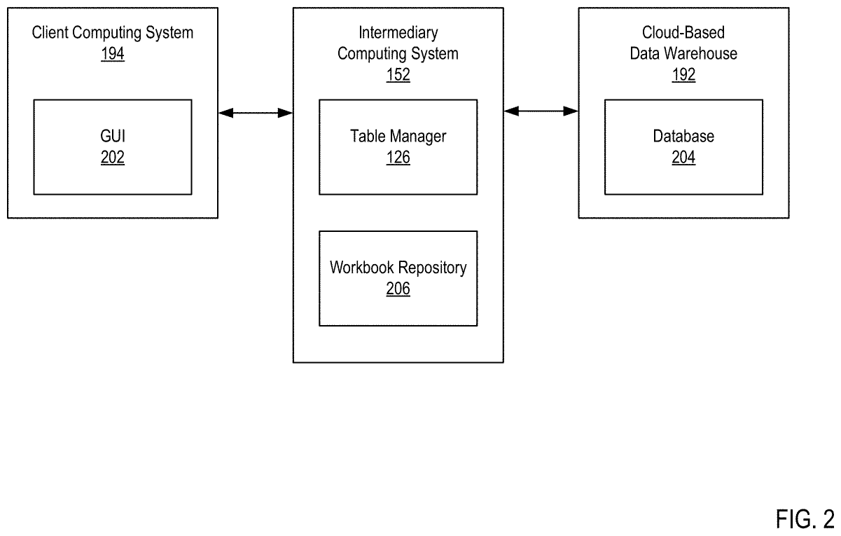

FIG. 2 shows an exemplary system for data visualization with derived dimensional hierarchy according to embodiments of the present invention. As shown in FIG. 2, the system includes a client computing system 194, an intermediary computing system 152, and a cloud-based data warehouse 192. The client computing system 194 includes a graphical user interface (GUI) 202. The intermediary computing system 152 includes a table manager 126 and a workbook repository 206. The cloud-based data warehouse 192 includes a database 204. The client computing system 194 may access the cloud-based data warehouse 192 and database 204 via the table manager on the intermediary computing system 152.

The GUI 202 is a visual presentation configured to present data sets in the form of workbooks to a user. The GUI 202 also receives requests from a user for data sets from the database 204. The GUI 202 may also present to the user the ability to add a new row into a data set or table and enter values for each column of the new row. The GUI 202 may be presented, in part, by the table manager 126 and displayed on a client computing system 194 (e.g., on a system display or mobile touchscreen). The GUI 202 may be part of an Internet application that includes the table manager 126 and is hosted on the intermediary computing system 152.

The database 204 is a collection of data and a management system for the data. A data set is a collection of data (such as a table) from the database 204. Data sets may be organized into columns and rows (also referred to as records). The particular columns, rows, and organization of the columns and rows that make up a data set may be specified in the database statement requesting the data set. Data sets may be sent from the cloud-based data warehouse 192 in response to a database statement (also referred to as a query). Accordingly, data sets retrieved in response to a database statement may be referred to as query results.

The table manager 126 is hardware, software, or an aggregation of hardware and software configured to receive instructions in the form of state specifications from the client computing system 194, via the GUI 202. The table manager 126 is also configured to present workbooks in the GUI 202 response to the instructions, which may include generating database statements in response to manipulations of the GUI 202 described in the state specification.

The state specification is a collection of data describing inputs into the GUI 202. The state specification may include manipulations of GUI elements within the GUI 202 along with data entered into the GUI 202 by a user of the client computing system 194. Such manipulations and data may indicate requests for and manipulations of data sets. Such manipulations and data may also indicate requests to edit an existing row or create a new row and values for that row. The state specification may be a standard file format used to exchange data in asynchronous browser-server communication. For example, the state specification may be a JavaScript Object Notation specification. The state specification may also include descriptions of elements that are used to apply changes to the data set. Such elements may include filters applied to the workbook, the hierarchical level of the workbook, joins performed within the workbook, exposable parameters in the workbook, and security for the workbook.

The table manager 126 may use the state specification as input to generate a database statement. This database statement generation process may begin with state specification being converted into an abstract syntax tree. The abstract syntax tree may then be canonicalized into a canonicalized hierarchy. The canonicalized hierarchy may then be linearized into the workbook algebra. The workbook algebra may then be lowered into a relational algebra, which may then be lowered into the database statement.

The table manager 126 may use the database statement to fetch query results (i.e. a data set) from the database 204. The table manager 126 may then present the query results to a user via the GUI 202. The table manager 126 may further manage tables on the database 202 to which a user has made edits, such as adding new rows or editing existing rows. Further, the table manager 126 may add columns to new rows and create new tables on the database 202.

The table manager 126 may service requests in the state specification using workbooks local to the table manager 126. A workbook is a presentation of a data set in the GUI 202. Specifically, a workbook is metadata describing a particular organization and configuration of a data set for presentation via the GUI 202. A workbook may include multiple elements including a visualization and a spreadsheet structure. For example, a workbook may include a spreadsheet structure presenting data points from a data set and an accompanying visualization may present a graph of the data points. Such workbooks may be stored in the workbook repository 206.

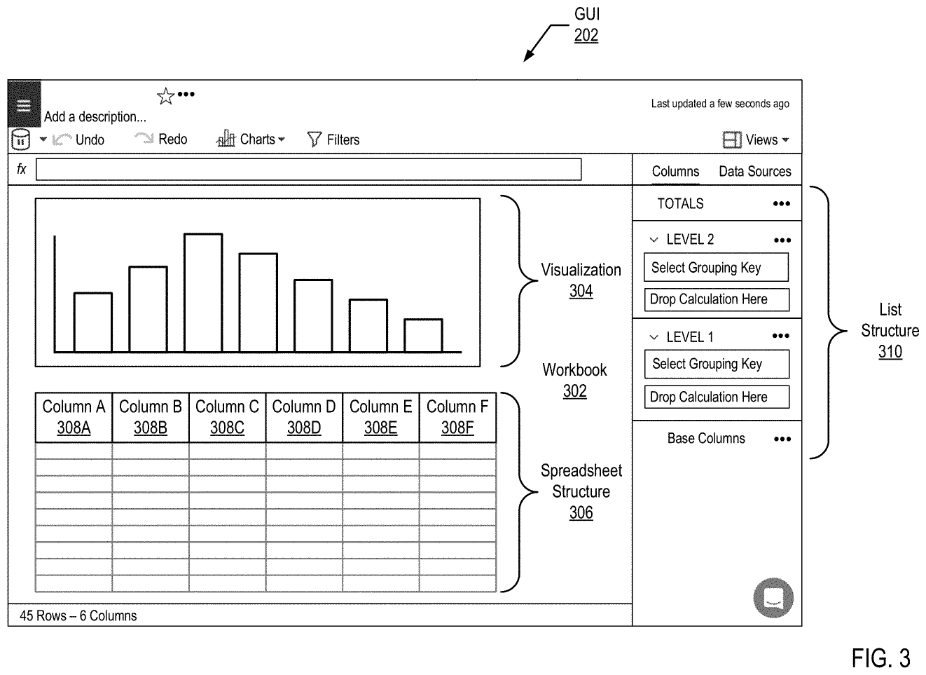

FIG. 3 shows an exemplary system for data visualization with derived dimensional hierarchy according to embodiments of the present invention. As shown in FIG. 3, the exemplary GUI 202 includes a workbook 302 and a list structure 310. The workbook 302 includes a visualization 304 and a spreadsheet structure 306 (shown as empty rows) with six columns (column A 308A, column B 308B, column C 308C, column D 308D, column E 308E, column F 308F).

The workbook 302 is a collection of graphical elements and organizing mechanism for a data set. The workbook may present a data set retrieved by the table manager from a cloud-based data warehouse. Specifically, the table manager may generate a database statement in response to the request from a client. The database statement may then be issued to the cloud-based data warehouse and the data set may be received as the query results of the database statement. The data set may then be organized based on the workbook retrieved from the workbook repository. The table manager itself may reside on an intermediary computing system between the client computing system and the cloud-based data warehouse.

As shown in FIG. 3, the workbook 302 includes a visualization 304 and a spreadsheet structure 306. The visualization 304 is a graphical element that conveys relationships between data in the data set. The visualization 304 may include, for example, graphs, charts, or maps. The spreadsheet structure 306 is a presentation of a data set (such as a table) from a database on a data warehouse. The spreadsheet structure 306 displays rows of data organized by columns (column A 308A, column B 308B, column C 308C, column D 308D, column E 308E, column F 308F). The columns delineate different categories of the data in each row. The columns may also be calculation columns that include calculation results using other columns in the spreadsheet structure 306. Both the visualization 304 and the spreadsheet structure 306 may include dynamic elements and be configured to interact with a client via the GUI 202.

The list structure 310 is a graphical element used to define and organize the hierarchical relationships between the columns (column A 308A, column B 308B, column C 308C, column D 308D, column E 308E, column F 308F) of the data set. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure 310 presents a dimensional hierarchy to the user. Specifically, the list structure 310 presents levels arranged hierarchically across at least one dimension. Each level within the list structure 310 is a position within a hierarchical relationship between columns (column A 308A, column B 308B, column C 308C, column D 308D, column E 308E, column F 308F). The keys within the list structure 310 identify the one or more columns that are the participants in the hierarchical relationship. Each level may have more than one key.

One of the levels in the list structure 310 may be a base level. Columns selected for the base level provide data at the finest granularity. One of the levels in the list structure 310 may be a totals or root level. Columns selected for the totals level provide data at the highest granular level. For example, the totals level may include a field that calculates the sum of each row within a single column of the entire data set (i.e., not partitioned by any other column).

The GUI 202 may enable a user to drag and drop columns (column A 308A, column B 308B, column C 308C, column D 308D, column E 308E, column F 308F) into the list structure 310. The order of the list structure 310 may specify the hierarchy of the columns relative to one another. A user may be able to drag and drop the columns in the list structure 310 at any time to redefine the hierarchical relationship between columns. The hierarchical relationship defined using the columns selected as keys in the list structure 310 may be utilized in charts such that drilling down (e.g., double click on a bar), enables a new chart to be generated based on a level lower in the hierarchy.

The GUI 202 may also include a mechanism for a user to request a table from a database to be presented as a workbook in the GUI 202. Such a mechanism may be part of the interactivity of the workbook. Specifically, a user may manipulate a workbook (e.g., by dragging and dropping columns or rows, resorting columns or rows, manipulating a graph etc.) and, in response, the GUI 202 may generate a request (e.g., in the form of a state specification) for a data set and send the request to the table manager 126. Such a mechanism may also include a direct identification of the rows and columns of a database table that a user would like to access (e.g., via a selection of the rows and columns in a dialog box). The GUI 202 may also include a mechanism for a user to create a new table on the database, add rows to a table, and move rows within the table.

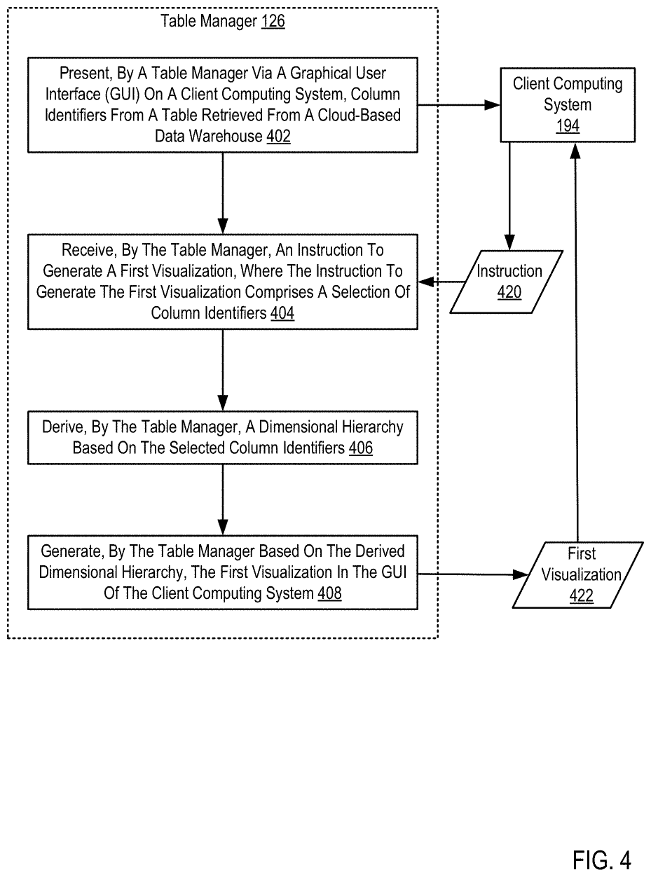

For further explanation, FIG. 4 sets forth a flow chart illustrating an exemplary method for data visualization with derived dimensional hierarchy according to embodiments of the present invention. Visualization and manipulation of data stored in a data warehouse may provide many insights into the data. Retrieving, manipulating, and visualization data stored in a data warehouse, however, requires knowledge and expertise related to database query formation and execution. Such knowledge and expertise may not be available to some users who may most desire such visualizations.

Further, visualization of data may be expressed in a more useful manner than a simple plot of a graph. Instead, visualization of data may be expressed in business intelligence (‘BI’) terms such a measures and dimensions. A dimension, in BI, refer to a category or aggregation of measures. Measures is data upon which calculations can be performed. A dimension, for example, may be “total sales in each region of the country” and the measure for each dimension may be an actual number of dollars. Such dimensions or aggregations may be hierarchical in nature. Consider “total sales in each region of the country” and also consider that the tables providing the data for such aggregations comprise tables having total sales per city, tables providing cities in each state, and a table comprising states for each region. In such an example, there is a hierarchy in place to calculate the sum of sales for region which includes levels of region, state, city, with the final level of hierarchy being the sales for each city. To calculate the final measure of total sales per region from raw data stored in a data warehouse, a user would normally need to construct one or more complex database queries to perform various selections of rows, groupings, sorts, and summations. A user without knowledge or expertise in formulating such would be effectively prohibited from creating a visualization from that raw data that represented total sales per region.

Turning to the method of FIG. 4, the method of FIG. 4 includes presenting 402, by a table manager 126 via a graphical user interface (GUI) on a client computing system 194, column identifiers from a table retrieved from a cloud-based data warehouse 192. Presenting 402 column identifiers from a table retrieved from a cloud-based data warehouse 192 may be carried out by retrieving the column identifiers from the table. A column identifier identifies a column in a table. The column identifier may be a label of the column within the table. The table, or portions thereof, may be retrieved from the cloud-based data warehouse 192 and stored on the intermediary computing system. The column identifiers may then be extracted from the table. Alternatively, the column identifiers may be extracted directly from the cloud-based data warehouse 192.

The method of FIG. 4 also includes receiving 404, by the table manager 126, an instruction 420 to generate a first visualization, wherein the instruction 420 to generate the first visualization 422 comprises a selection of column identifiers. Upon being presented, via the GUI, with a list of column identifiers, a client using the client computing system 194 may select one or more of the column identifiers presented. Receiving 404 the instruction 420 to generate the first visualization may be carried out by detecting that the client on the client computing system 194 has manipulated elements of the GUI and/or submitted data using the GUI such that the generation of the instruction 420 is triggered, and the instruction 420 is sent to the table manager 126. The instruction 420 may be received in the form of a state specification from the GUI.

The selection of column identifiers may include an identifier of a calculation column. Specifically, the client may select a column that calculates a value using values from another column or columns as input. The calculation column may have been previously added to the table by the current client or another client.

In addition to the selection of column identifiers, the instruction 420 to generate the first visualization 422 may also include additional information about the first visualization 422 to be generated. For example, the instruction 420 may include the type of visualization to be generated (e.g., bar chart, line graph, etc.), constraints, parameters, and an association between each selected column identifier and an axis of the graph, along with any calculations (e.g., sum, average, count, etc.).

The method of FIG. 4 also includes deriving 406, by the table manager 126, a dimensional hierarchy based on the selected column identifiers. Deriving 406 the dimensional hierarchy based on the selected column identifiers may be carried out by determining a relationship between the columns identified by the selected column identifiers; and generating source data for the first visualization based on the determined relationship between the columns identified by the selected column identifiers. Determining the relationship between the selected columns may include evaluating the contents of each selected column to generate an order between the columns and any intervening columns between the two selected columns.

For example, a client may want to create a bar graph that displays the population of each state. The client may generate an instruction that includes a selection of a “Population” column and a selection of “State” column. The tables in the cloud-based data warehouse may not associate the population with a state directly. Instead, the “Population” column is related to county names, county names are then related to zip codes, and zip codes are related to states. To sum the population per state then infers a hierarchy of dimensions in this order: State, Zip Code, County Names, Population. Rather than a user specifying this hierarchy directly, modifying a number of spreadsheets or tables to specify this hierarchy, the interface derives the hierarchy from the visual parameter specifications.

Generating source data for the first visualization based on the determined relationship may include the formation and execution of one or more database statements to retrieve, aggregate or otherwise modify the data to be presented according to the derived hierarchy. Specifically, deriving the dimensional hierarchy may include creating a portion of a database statement that will be used, along with other portions of the database statement, to retrieve the underlying data for the visualization.

The method of FIG. 4 also includes generating 408, by the table manager 126 based on the derived dimensional hierarchy, the first visualization 422 in the GUI of the client computing system 194. Generating 408 the first visualization 422 based on the derived dimensional hierarchy may be carried out by generating a database statement targeting the cloud-based data warehouse using the derived dimensional hierarchy. The database statement may include elements from each layer from which first visualization is created. The database statement may be created from elements describing the visualization that are combined with elements describing the portion of the source table. A source table is a portion of the table from the cloud-based data warehouse that has been retrieved and may be presented in a portion of the workbook. The source table may be manipulated before being used to create a visualization or other elements.

Each visualization includes information about ancestor visualizations and source tables, and each visualization and source table is associated with a portion of a database statement (or intermediary form). To generate a complete database statement to retrieve the data necessary to preset the visualization, each portion of the database statement is extracted from each ancestor visualization and source table. The combined database statement is then issued to the cloud-based data warehouse and the query results are then used to generate the final visualization. The database statement may be a structured query language statement.

The above limitations improve the operation of the computer system by enabling a user to generate visualizations without interacting with the underlying data. The data forming the visualization has been retrieved, aggregated, and otherwise modified by forming, based on the derived hierarchy, one or more database statements and executing those database statements in the database on the data warehouse. Notice, there is no additional interaction necessary by the user. In fact, the user, other than selecting the source of the data, does not actually need to interact with the data in its original format or otherwise view the data in a more traditional tabular format. Such a tabular format, however, is another valuable way of viewing the data and as such, the table manager, having already derived the hierarchy and applied it to the data of the data source can easily display the same data of the bar chart in a tabular format.

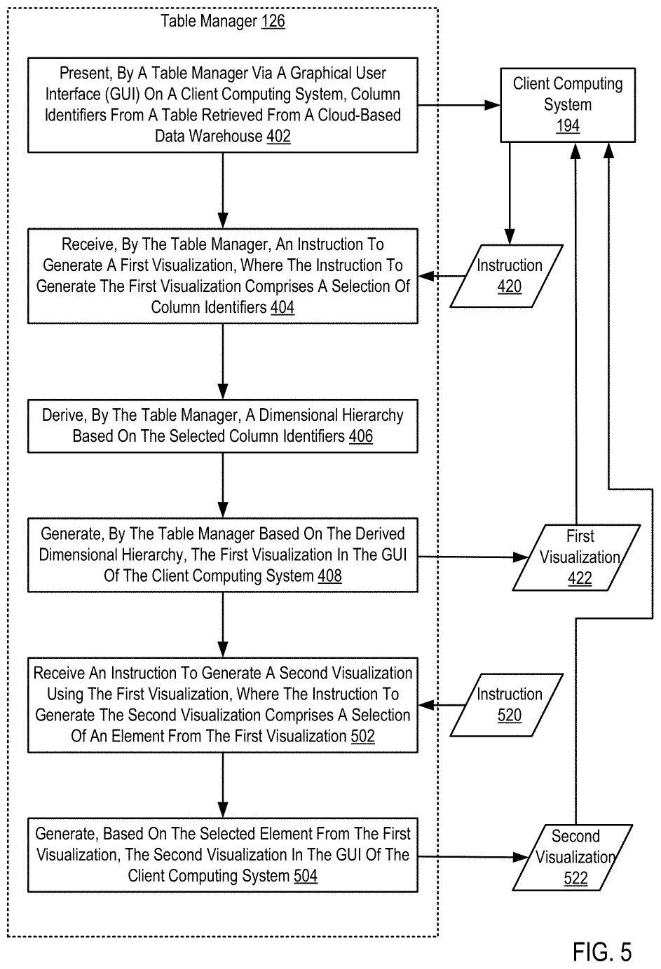

For further explanation, FIG. 5 sets forth a flow chart illustrating a further exemplary method for data visualization with derived dimensional hierarchy according to embodiments of the present invention that includes presenting 402, by a table manager 126 via a graphical user interface (GUI) on a client computing system 194, column identifiers from a table retrieved from a cloud-based data warehouse 192; receiving 404, by the table manager 126, an instruction 420 to generate a first visualization, wherein the instruction 420 to generate the first visualization 422 comprises a selection of column identifiers; deriving 406, by the table manager 126, a dimensional hierarchy based on the selected column identifiers; and generating 408, by the table manager 126 based on the derived dimensional hierarchy, the first visualization 422 in the GUI of the client computing system 194.

The method of FIG. 5 differs from the method of FIG. 4, however, in that the method of FIG. 5 further includes receiving 502 an instruction 520 to generate a second visualization 522 using the first visualization 422, wherein the instruction 520 to generate the second visualization 522 comprises a selection of an element from the first visualization 422; and generating 504, based on the selected element from the first visualization 422, the second visualization 522 in the GUI of the client computing system 194.

Receiving 502 the instruction 424 to generate a second visualization 426 using the first visualization 422 may be carried out by receiving a selection of an element from the first visualization 422 and an indication that the second visualization should be created based on the selected element. The instruction 424 may also include a selection by the client of a different level of granularity (e.g., from state to zip code or county). Generating 504 the second visualization 426 based on the selected element from the first visualization 422 may be carried out by generating a database statement targeting the cloud-based data warehouse using the selected element of the first visualization. As before, the database statement may include elements from each layer from which second visualization is created, including the first visualization and the source table.

Continuing with the example visualization depicting population by state, a client may select “Texas” from the first visualization and be presented with an option to create the second visualization using a different level of granularity (e.g., zip code or county). The user may then select county. The table manager 126 receives the instruction and generates the second visualization showing the populations of each county in Texas. The second visualization is generated by compiling a database statement that includes the selection of “county” as well as the elements from the first visualization depicting the population of each state.

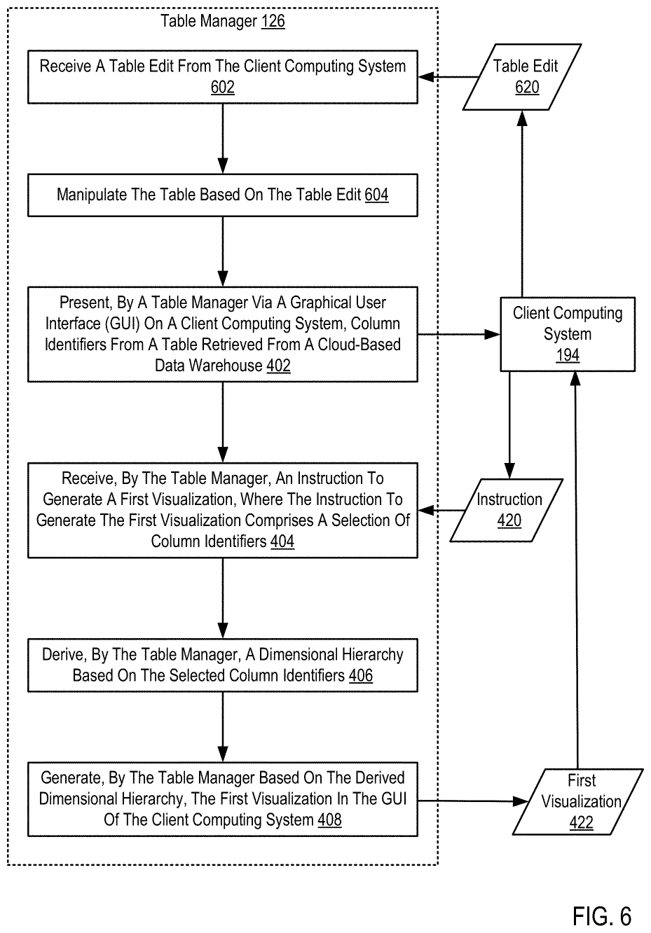

For further explanation, FIG. 6 sets forth a flow chart illustrating a further exemplary method for data visualization with derived dimensional hierarchy according to embodiments of the present invention that includes presenting 402, by a table manager 126 via a graphical user interface (GUI) on a client computing system 194, column identifiers from a table retrieved from a cloud-based data warehouse 192; receiving 404, by the table manager 126, an instruction 420 to generate a first visualization, wherein the instruction 420 to generate the first visualization 422 comprises a selection of column identifiers; deriving 406, by the table manager 126, a dimensional hierarchy based on the selected column identifiers; and generating 408, by the table manager 126 based on the derived dimensional hierarchy, the first visualization 422 in the GUI of the client computing system 194.

The method of FIG. 6 differs from the method of FIG. 4, however, in that FIG. 6 further includes receiving 602 a table edit 620 from the client computing system 194; and manipulating 604 the table based on the table edit 620. Receiving 602 the table edit 620 from the client computing system 194 may be carried out by the client instructing the table manager 126 to modify a source table in the workbook. The table edit may be the addition of a calculation column that uses one or more other columns as input. Other examples of table edits include one or more additional rows of data, the modification of an existing column calculation, a rearranging of columns in the source table, a filtering of rows in the source table, and the removal of one or more columns.

Manipulating 604 the table based on the table edit 620 may be carried out by executing the table edit on the source table according to the content of the table edit. Once the table edit is incorporated into the source table, the workbook with the table edit may be stored, along with any visualizations, in the workbook repository (e.g., on the intermediary computing system). The subsequent selection of column identifiers may include an identifier of at least one column targeted by the table edit. For example, a visualization may use, as one axis, a calculation column added to the source table via the table edit.

In view of the explanations set forth above, readers will recognize that the benefits of data visualization with derived dimensional hierarchy according to embodiments of the present invention include:
Improving the operation of the computer system by enabling a user to generate visualizations without interacting with the underlying data, increasing system utility.
Improving the operation of the computer system by abstracting data evaluation lowering the bar for data analysis, increasing system utility.

Exemplary embodiments of the present invention are described largely in the context of a fully functional computer system for data visualization with derived dimensional hierarchy. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for data visualization with derived dimensional hierarchy, the method comprising:
presenting, by a table manager via a graphical user interface (GUI) on a client computing system, column identifiers from a table retrieved from a cloud-based data warehouse;
receiving, by the table manager, an instruction to generate a first visualization, wherein the instruction to generate the first visualization comprises a selection of column identifiers;
deriving, by the table manager, a dimensional hierarchy based on the selected column identifiers; and
generating, by the table manager based on the derived dimensional hierarchy, the first visualization in the GUI of the client computing system.

2. The method of claim 1, further comprising:
receiving an instruction to generate a second visualization using the first visualization, wherein the instruction to generate the second visualization comprises a selection of an element from the first visualization; and
generating, based on the selected element from the first visualization, the second visualization in the GUI of the client computing system.

3. The method of claim 1, further comprising:
receiving a table edit from the client computing system; and
manipulating the table based on the table edit.

4. The method of claim 3, wherein the selection of column identifiers refers to at least one column targeted by the table edit.

5. The method of claim 3, wherein the table edit and the first visualization are stored in a workbook repository on an intermediary computing system.

6. The method of claim 1, wherein deriving the dimensional hierarchy based on the selected column identifiers comprises:
determining a relationship between the columns identified by the selected column identifiers; and
generating source data for the first visualization based on the determined relationship between the columns identified by the selected column identifiers.

7. The method of claim 1, wherein generating, based on the derived dimensional hierarchy, the first visualization in the GUI of the client computing system comprises generating a database statement targeting the cloud-based data warehouse using the derived dimensional hierarchy.

8. The method of claim 7, wherein the database statement is a structured query language statement.

9. The method of claim 1, wherein the selection of column identifiers comprises an identifier of a calculation column.

10. The method of claim 1, wherein the table manager is executing on an intermediary computing system between the client computing system and the cloud-based data warehouse.

11. An apparatus for data visualization with derived dimensional hierarchy, the apparatus comprising a computer processor, a computer memory operatively coupled to the computer processor, the computer memory having disposed within it computer program instructions that, when executed by the computer processor, cause the apparatus to carry out the steps of:
presenting, by a table manager via a graphical user interface (GUI) on a client computing system, column identifiers from a table retrieved from a cloud-based data warehouse;
receiving, by the table manager, an instruction to generate a first visualization, wherein the instruction to generate the first visualization comprises a selection of column identifiers;
deriving, by the table manager, a dimensional hierarchy based on the selected column identifiers; and
generating, by the table manager based on the derived dimensional hierarchy, the first visualization in the GUI of the client computing system.

12. The apparatus of claim 11, wherein the computer program instructions further cause the apparatus to carry out the steps of:
receiving an instruction to generate a second visualization using the first visualization, wherein the instruction to generate the second visualization comprises a selection of an element from the first visualization; and
generating, based on the selected element from the first visualization, the second visualization in the GUI of the client computing system.

13. The apparatus of claim 11, wherein the computer program instructions further cause the apparatus to carry out the steps of:
receiving a table edit from the client computing system; and
manipulating the table based on the table edit.

14. The apparatus of claim 13, wherein the selection of column identifiers refers to at least one column targeted by the table edit.

15. The apparatus of claim 13, wherein the table edit and the first visualization are stored in a workbook repository on an intermediary computing system.

16. The apparatus of claim 11, wherein deriving the dimensional hierarchy based on the selected column identifiers comprises:
determining a relationship between the columns identified by the selected column identifiers; and
generating source data for the first visualization based on the determined relationship between the columns identified by the selected column identifiers.

17. The apparatus of claim 11, wherein generating, based on the derived dimensional hierarchy, the first visualization in the GUI of the client computing system comprises generating a database statement targeting the cloud-based data warehouse using the derived dimensional hierarchy.

18. The apparatus of claim 17, wherein the database statement is a structured query language statement.

19. The apparatus of claim 11, wherein the selection of column identifiers comprises an identifier of a calculation column.

20. A computer program product for data visualization with derived dimensional hierarchy, the computer program product disposed upon a computer readable medium, the computer program product comprising computer program instructions that, when executed, cause a computer to carry out the steps of:
presenting, by a table manager via a graphical user interface (GUI) on a client computing system, column identifiers from a table retrieved from a cloud-based data warehouse;
receiving, by the table manager, an instruction to generate a first visualization, wherein the instruction to generate the first visualization comprises a selection of column identifiers;
deriving, by the table manager, a dimensional hierarchy based on the selected column identifiers; and
generating, by the table manager based on the derived dimensional hierarchy, the first visualization in the GUI of the client computing system.
